(19) United States
(12) Patent Application Publication
(10) Pub. No.: US 2013/0094595 A1
(43) Pub. Date: Apr. 18, 2013

(54) Method for Channel Estimation Using Cell Specific Reference Symbols

(71) Applicants: Konstantinos Dimou, Stockholm (SE); Erik Dahlman, Bromma (SE); Robert Baldemair, Solna (SE)

(72) Inventors: Konstantinos Dimou, Stockholm (SE); Erik Dahlman, Bromma (SE); Robert Baldemair, Solna (SE)

(73) Assignee: TELEFONAKTIEBOLAGET LM ERICSSON (PUBL), Stockholm (SE)

(21) Appl. No.: 13/703,521

(22) PCT Filed: Jun. 30, 2010
(86) PCT No.: PCT/SE2010/050753

§ 371 Date: Dec. 11, 2012

(51) Int. Cl. H04W 24/00

(52) U.S. Cl. CPC H04W 24/00
USPC 375/252

(57) ABSTRACT

The invention relates to a method in a user equipment for channel estimation, the user equipment communicating within a wireless communication system comprising at least two cells arranged in a layered structure, the at least two cells using at least partly overlapping bandwidth. The user equipment communicates with a base station of an underlaid cell of the layered structure, and the Select resource method comprises the steps of: selecting, from elements carrying CRSs among resource blocks scheduled for the user equipment in the underlaid cell, resource elements carrying cell specific reference symbols, wherein the resource blocks are within bandwidth used by the underlaid cell; and performing the channel estimation by utilizing the selected resource elements carrying cell specific selected resource reference symbols. The invention also relates elements carrying CRSs to user equipment implementing the method.

### FIELD OF THE INVENTION

The present invention relates generally to the field of wireless communication and, in particular, to methods and arrangements for channel estimation in a user equipment of a wireless communication system.

### BACKGROUND OF THE INVENTION

LTE (Long-term evolution) is a project within the 3GPP (3rd Generation Partnership Project) with an aim to improve the UMTS (Universal Mobile Telecommunications System) mobile phone standard for coping with future technology evolutions.

Heterogeneous network (HetNet) is an item of interest in the development of LTE-Advanced. HetNets have for example been considered for complementing macro cell layouts in order to handle non-uniform traffic distributions. Macro cells could be used in certain areas primarily for coverage and smaller cells underlaid the macro cells could be used for high capacity needs at traffic hotspots.

In HetNets comprising a mixture of differently sized cells with overlapping coverage areas, e.g. a number of micro and pico cells overlaid by a macro cell, the cells have different characteristics. As an example, in terms of output power the micro cells typically communicate on considerably lower output power than the macro cell.

A conventional approach is to apply complete frequency separation between the different cells, or different layers, and operate the different layers on different non-overlapping carrier frequencies, thereby avoiding any interference between the layers. With no macro cell interference towards the underlaid cells, advantages of the cell splitting are obtained since all resources can be used simultaneously by the underlaid cells. A drawback of this approach is that the resource utilization is not optimized.

Another approach is to have the cells operating at least partly on same set of frequencies. Better utilization of network resources would follow, but inter-cell interference then has to be handled. Classical inter-cell interference coordination (ICIC) methods, such as frequency reuse or fractional frequency reuse, can generally be applied.

However, although such ICIC methods are applicable for data transmissions, they cannot be used for all types of signal transmission. Synchronization signals (PSS/SSS), physical broadcast channel (PBCH), L1/L2 control channels (PDCCH, PCFICH, PHICH) and cell specific reference signals (CRS), are a few examples of signaling that need to be transmitted on specific, well-defined resources. Efficient interference handling is required also for this type of signaling.

CRSs for example, are transmitted over the whole system bandwidth. ICIC could be applied in the time domain, i.e. transmitting the CRS at given time sub-frames only by the macro-cell, during which time the underlaid cells are muting their respective transmission of CRS. However, channel estimation would be difficult in the total absence of reference signals. Further, CRS would be interfering with physical downlink shared channel (PDSCH) and CRS heavily interfered by PDSCH would run the risk of obtaining faulty channel estimation.

From the above it is clear that interference management is an important issue in the development of LTE-Advanced. It would be desirable to provide reliable and effective interference handling methods for control signalling.

### SUMMARY OF THE INVENTION

One aspect of the present invention is directed towards arrangements and methods for interference management of control signalling in heterogeneous cell layouts, and in particular for inter-layer interference management for cell specific reference signals (CRSs).

This aspect is according to a first variation of the invention obtained through a method, in a user equipment, for channel estimation, the user equipment communicating within a wireless communication system. The wireless communication system comprises at least two cells arranged in a layered structure, wherein the at least two cells uses at least partly overlapping bandwidth. The user equipment communicates with a base station of an underlaid cell of the layered structure. The method comprises the steps of: selecting, from among resource blocks scheduled for the user equipment in the underlaid cell, resource elements carrying cell specific reference symbols, wherein the resource blocks are within bandwidth used by the underlaid cell; and performing the channel estimation by utilizing the selected resource elements carrying cell specific reference symbols.

By means of the invention, the user equipment is set to only use resource elements carrying cell specific reference symbols that are not interfered by base station transmissions of overlaid cell. Improved channel estimation enables improved data throughput. Further, the invention provides an improved utilization of the total signaling resources, and also a flexible use thereof.

According to one variation of the invention, the step of selecting comprises the sub-step of rejecting resource elements carrying cell specific reference symbols overlapping with resource elements used for control signalling by a base station of the overlaid cell. The user equipment may thus be instructed not to use the CRSs that overlaps with overlaid base station control signaling, whereby an improved channel estimation can be obtained in that interfered CRSs are avoided.

According to another variation of the invention, the step of selecting comprises the sub-step of the user equipment estimating an interference level of the resource blocks and basing the selection thereon. Different interference estimation methods can be chosen between, thereby providing flexibility.

According to yet another variation, the step of selecting comprises the sub-step of additionally selecting resource elements from among bandwidth not used by overlaid cell. By this feature, available, non-used resource elements may be used for improving the channel estimation even further.

According to still another variation, the step of selecting comprises the sub-steps of: detecting that no overlaid cell users are scheduled in accessible resource blocks; and additionally selecting resource elements carrying cell specific reference symbols from among the accessible resource blocks. Yet further improved channel estimation may then be obtained.

According to the same variation, the sub-step of detecting comprises the user equipment determining interference from the accessible resource blocks by means of energy detection. Again, known interference determination methods may be used, rendering the method flexible.

According to another variation of the invention, the step of selecting comprises the user equipment obtaining signaling from the base station, the signaling indicating which resource elements carrying cell specific reference symbols should be used for the channel estimation. The signaling from the base station is, in a further variation of the invention, indicating which resource elements carrying cell specific reference symbols should not be used for the channel estimation. Other ways of selecting which CRSs to use are thus provided, yet again rendering design flexibility to the method.

According to another variation of the invention, the resource blocks scheduled for the user equipment in the underlaid cell comprises PDSCH bandwidth.

The invention is also related to a user equipment comprising means for implementing the above method, whereby advantages corresponding to the above-mentioned are achieved.

In particular, in a variation of the invention user equipment for communication within a wireless communication system is provided. The wireless communication system comprises at least two cells arranged in a layered structure, wherein the at least two cells use at least partly overlapping bandwidths, and the user equipment communicates with a base station of an underlaid cell of the layered structure. The user equipment comprises: one or more processing circuits configured to select, from among resource blocks scheduled for the user equipment in the underlaid cell, resource elements carrying cell specific reference symbols, wherein the resource block comprises bandwidth used by the underlaid cell. The user equipment further comprises one or more processing circuits configured to perform the channel estimation by utilizing the selected resource elements carrying cell specific reference symbols.

In a variation of the invention, the user equipment further comprising one or more processing circuits configured to perform an additional selection of resource elements carrying cell specific reference symbols from among bandwidth not used by the overlaid cell.

Further features and advantages thereof will become clear upon reading the following detailed description and the accompanying drawings.

### BRIEF DESCRIPTION OF THE DRAWINGS

The invention will now be described in more detail with reference to the enclosed drawings, in which:

FIG. 1 illustrates a sub-frame for downlink transmissions in e.g. LTE systems.

FIG. 2 illustrates a wireless communication network in which the present invention may be implemented.

FIG. 3 illustrates sub-frames of a layered cell structure.

FIG. 4 illustrates transmissions from cells of a layered cell structure.

FIG. 5 illustrates a flow chart over steps included in a method in accordance with the present invention.

FIG. 6 illustrates a user equipment in accordance with the invention.

FIG. 7 illustrates an embodiment of the invention.

### DETAILED DESCRIPTION OF EMBODIMENTS OF THE INVENTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

In order to provide a thorough understanding of the present invention, some general concepts in wireless communication systems are briefly described initially in the following.

In OFDM systems, such as LTE systems, certain symbols in the time-frequency grid defined by the OFDM signal are designated as reference symbols. These reference symbols have a value that is known to the receiver of the OFDM signal and are used by the receiver as pilot symbols in order to characterize the propagation channel between the transmitter and receiver, and to estimate the noise and interference variation of the received signal. The channel estimates and noise-plus-interference estimates are used to calculate an estimated signal-to-interference ratio (SIR) for use in demodulation of the information symbols and thus decoding received communication signals. The protection of these pilot symbols from other cell interference is important. In LTE, such pilot symbols are called reference symbols and the sequences formed by several pilot symbols is called reference signal.

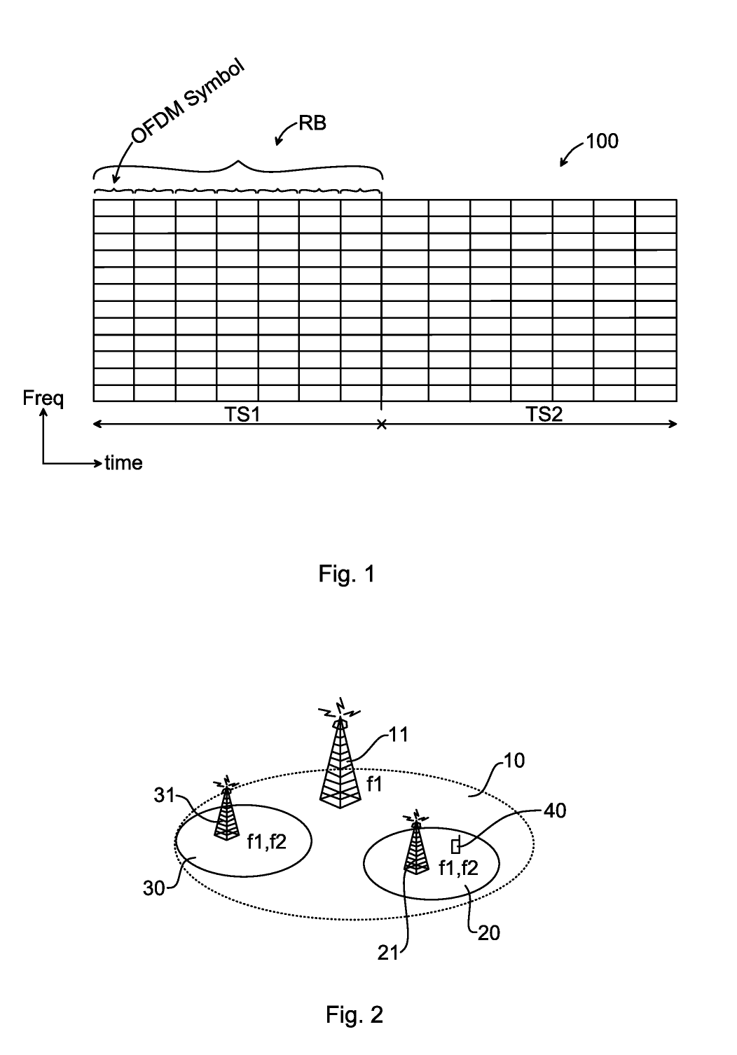

FIG. 1 illustrates a sub-frame 100 for downlink transmissions in e.g. LTE systems. The sub-frame 100 comprises in time domain two slots TS1, TS2 and each time slot comprises seven OFDM symbols, assuming normal cyclic prefix. A resource block RB comprises in the frequency direction 12 sub-carriers and in the time direction seven OFDM symbols. An exemplary scheduling unit to a user equipment comprises 12 sub-carriers over one sub-frame, i.e. two resource blocks RBs. If a user needs more bandwidth multiples of 12 subcarriers can be scheduled for the user. Cells typically use different locations and pattern for the reference symbols, hence denoted cell-specific reference signals (CRS).

FIG. 2 illustrates a layered cell structure in a wireless communication system 1 in which the present invention may be implemented. In particular, a cellular layout is shown having an overlaid cell 10, also denoted macro cell in the following, and a first and a second underlaid cell 20, 30, also denoted first and second pico cells, respectively, in the following. That is, the coverage areas of the pico cells 20, 30 lie within the coverage area of the macro cell 10.

The macro cell 10 comprises a base station 11 (denoted evolved Node B or eNB in LTE) transmitting, in the exemplifying case of FIG. 1, on carrier bandwidth fl. The first and second pico cells 20, 30 comprise a respective base station 21, 31, which are also transmitting on carrier bandwidth fl and further on carrier bandwidth f2. The use of overlapping carrier bandwidths for the cells 10, 20, 30 is brought about by operators desire to maximize utilization of their available bandwidth. The macro cell 10 and the first and second pico cells 20, 30 thus have partly overlapping carrier bandwidths. As an example, a 20 MHz bandwidth segregated into two (10 MHz bandwidth) carrier bandwidths f1 and f2 could be used within the coverage area of the macro cell 10. Therein, the carrier bandwidth fl is used by the macro cell 10, while the first and second pico cells 20, 30 use both f1 and f2.

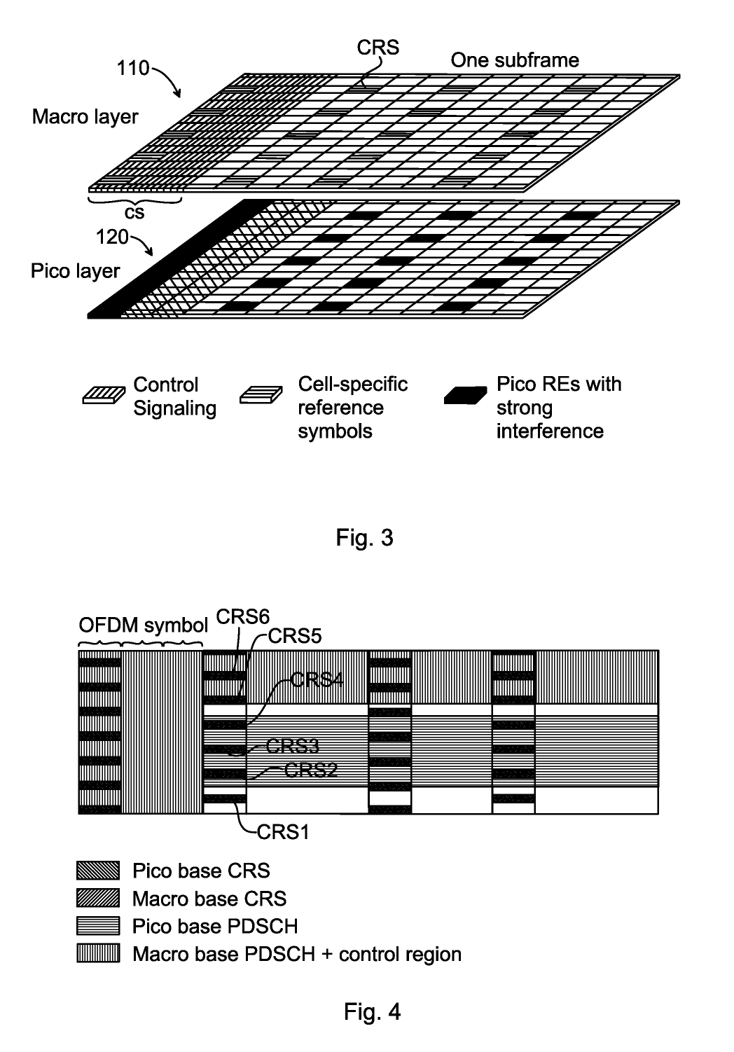

The interference scenario described in the background section is described in some more detail in the following, with reference to FIGS. 3 and 4, giving a frame of reference for the invention.

It can be expected that CRSs transmitted in carrier fl in the first and second pico cells 20, 30 are going to experience high interference, especially from CRSs and PDSCH transmitted in the overlaid macro cell 10.

Interference caused by CRSs transmissions from macro base station 11 towards pico base station 21 could be avoided by transmitting CRS only at given time sub-frames by the macro cell 10 while the pico cells 20, 30 simultaneously mute their respective transmission of CRSs. Alternatively, the transmission of CRS from pico cells 20, 30 could be shifted in frequency so as to not collide with CRS transmissions from the macro cell 10. In case of shifting the transmission of CRSs in time or frequency, a problem is that CRS are interfering with PDSCH, which is illustrated in FIG. 3. FIG. 3 illustrates sub-frames of a layered cell structure and in particular the described interference situation between CRSs and PDSCH resource elements.

In the FIG. 3, a macro layer sub-frame and a pico layer sub-frame are illustrated. The three first OFDM symbols in the macro layer 110 are dedicated for control signaling, indicated at CS in the FIG. 3. Pico resource elements in the pico layer 120 that experience strong interference from the macro base station 11 are indicated by black squares. Squares in the macro layer 110 provided with horizontal lines, and one of which is denoted by CRS, are cell-specific reference symbols.

FIG. 4 illustrates PDSCH and CRS transmissions from macro base station 11 and first pico base station 21. The control signaling region of the macro cell 10 is three OFDM symbols, as illustrated. The pico base station 21 PDSCH starts at the fourth OFDM symbol. Further, in FIG. 4, resource elements carrying cell specific reference symbols CRS1, CRS2, CRS3, CRS4, CRS5, CRS6 are illustrated.

Interference stemming from PDSCH transmission from macro base station received by the user equipment 40 connected to the pico base station 21 can be mitigated by suitable inter-cell interference coordination, e.g. by not scheduling macro and pico base station PDSCH on same resource elements. However, the CRSs transmitted from the pico base station 21 are still heavily interfered by macro base station PDSCH transmission.

In accordance with embodiments of the invention, only those resource elements of the pico cell CRS that are within the own scheduled bandwidth for the user equipment 40 in the pico cell 20 are used for channel estimation. In the illustrated case, this would be carrier fl. Thereby the user equipment 40 is able to obtain an accurate channel estimation based on the CRSs received.

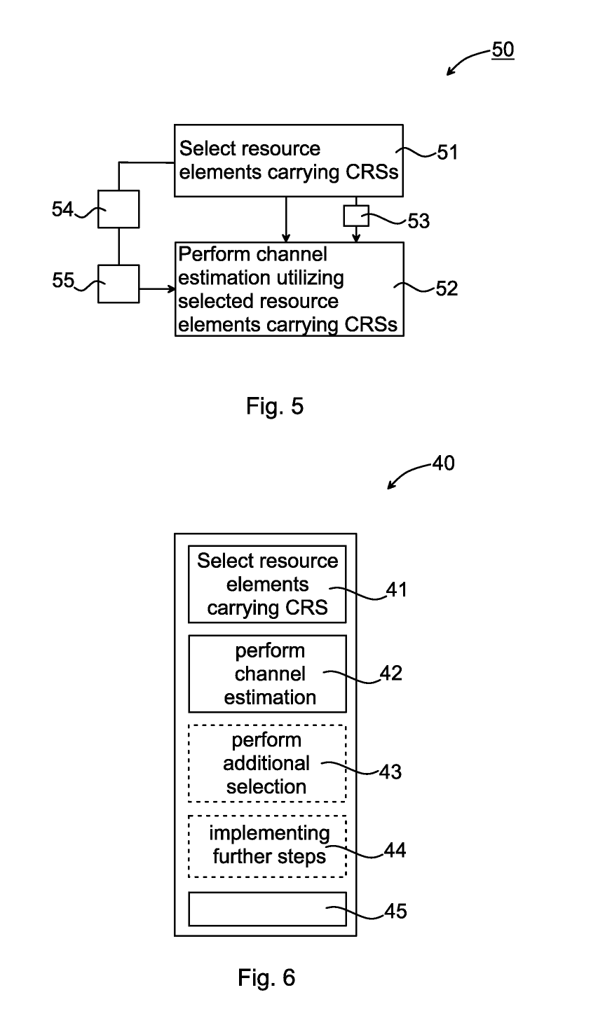

With reference to FIG. 5, steps of a method 50 in accordance with particular embodiments of the invention are illustrated. It is noted that further steps, not illustrated, may be included in the method. The method 50 is implemented in the user equipment 40 and used for obtaining reliable channel estimation. The user equipment 40 is communicating within the wireless communication system 1 as described, wherein the cells of the layered structure signal at least partly on overlapping bandwidth. In this situation, embodiments of the invention provides an improved way of obtaining a reliable channel estimation based on CRSs, in that not all available CRSs are used, but instead a selection is performed. The method 50 thus comprises the first step 51 of selecting, from among resource blocks scheduled for the user equipment 40 that is connected to the underlaid cell 20, 30, resource elements carrying cell specific reference symbols CRS1, CRS2, CRS3, CRS4, CRS5, CRS6. The resource blocks are within bandwidth f1, f2 used by the underlaid cell 20, 30. The user equipment 40 may obtain position of the CRSs that should be used for channel estimation from the base station 21, 31.

The method 50 comprises the second step of performing 52 the channel estimation by utilizing only the selected resource elements carrying cell specific reference symbols CRS1, CRS2, CRS3, CRS4, CRS5, CRS6.

Only resource elements carrying CRSs that are not interfered by macro base station transmissions are selected for use.

In an embodiment, the step of selecting 51 comprises the sub-step of the user equipment 40 estimating an interference level of the resource blocks RBs containing CRS, the RBs on fl and potentially on f2 and basing the selection thereon.

As can be seen from FIG. 4, fl is heavily interfered by transmissions from the macro base station 11, and reliable control information can therefore not be sent on f1 in the first and second pico cells 20, 30. In an embodiment of the invention, the step of selecting 51 therefore comprises the sub-step of rejecting resource elements carrying cell specific reference symbols CRS1, CRS2, CRS3, CRS4, CRS5, CRS6 that overlaps with resource blocks used for control signalling by the base station 11 of the overlaid cell 10.

In another embodiment, the step of selecting 51 therefore comprises the sub-step 53 of additionally selecting resource elements from among bandwidth f1, f2 not used by the overlaid cell.

There may be resource elements carrying CRSs that are neither scheduled by the pico base station 21, nor by the macro base station 11 and the resource blocks comprising such resource elements carrying CRSs are thus accessible for use for selection. In an embodiment of the invention, also such resource elements carrying CRSs are used. In particular, the step of selecting 51 then comprises the sub-steps of:
detecting 54 that no overlaid cell 10 users are scheduled in accessible resource blocks, and
additionally selecting 55 resource elements carrying cell specific reference symbols from among the detected accessible resource blocks.

Even further improved channel estimation is then obtained in that the channel estimation is based on additional non-interfered CRSs.

In the above embodiment, the sub-step of detecting 54 could be done in any suitable manner. For example, the user equipment 40 may for this end determine interference levels from the accessible resource blocks by means of energy detection. It is noted that other known interference measurements could alternatively be used.

The base station could explicitly signal to the user equipment 40 which resource elements carrying the CRSs that should be used for channel estimation. In yet another embodiment of the method 50, the step of selecting 51 therefore comprises the user equipment 40 obtaining signaling from the base station 21. The signaling indicates which resource elements carrying cell specific reference symbols that should be used for the channel estimation.

In an alternative embodiment, the signaling from the base station indicates which resource elements carrying cell specific reference symbols should not be used by the user equipment 40 in the channel estimation.

The signaling can be done dynamically by including the required information in the assignment, which is reliably transmitted on the other carrier bandwidth f2, i.e. non-overlapping bandwidth, or be configured. The latter approach is useful if carrier bandwidth fl is rather statically partitioned into frequency regions that are exclusively used by either macro or pico base stations. The user equipment 40 is then configured to know which resource elements carrying CRSs to use for the channel estimation. Alternatively, the user equipment 40 is informed of the bandwidth portion assigned to pico base station 21 or the bandwidth portion assigned to macro base station 11 and derives the usable CRS resource elements.

In a particular embodiment, the resource blocks scheduled for the user equipment 40 in the underlaid cell comprises its own scheduled PDSCH bandwidth.

With reference now to FIG. 6, the invention also encompasses a user equipment 40, in which the above method may be implemented by including suitable processing circuitry.

In particular, the user equipment 40 is suitable for communication within the wireless communication system 1 as described and comprises one or more processing circuits 41 configured to select, from among resource blocks scheduled for the user equipment 40 in the underlaid cell 20, 30, resource elements carrying cell specific reference symbols, wherein the resource blocks are comprised in bandwidth f1, f2 used by the underlaid cell 20, 30. The user equipment 40 further comprises one or more processing circuits 42 configured to perform the channel estimation by utilizing the selected resource elements carrying cell specific reference symbols.

The user equipment 40 may further comprise one or more processing circuits 43 configured to perform an additional selection of resource elements carrying cell specific reference symbols from among sub-carriers not used by the overlaid cell.

Yet additional processing circuits, generally indicated at reference numeral 44, may be included in the user equipment for performing one or more of the steps in the above described embodiments of the method 50, i.e. for implementing further, optional steps of the method 50.

In particular, processing circuitry may be provided for estimating an interference level of the resource blocks and basing the selection thereon.

Processing circuitry may be provided for rejecting resource elements carrying cell specific reference symbols CRS1, CRS2, CRS3, CRS4, CRS5, CRS6 that overlaps with resource elements used for control signalling by the base station 11 of the overlaid cell 10.

Processing circuitry may be provided for additionally selecting resource elements from among bandwidth f1, f2 not used by the overlaid cell.

Processing circuitry may be provided for detecting that no overlaid cell 10 users are scheduled in accessible resource blocks, and additionally selecting resource elements carrying cell specific reference symbols from among the detected accessible resource blocks. Such processing circuitry could comprise interference determining means.

Processing circuitry may be provided for receiving and processing signals from the base station explicitly stating which resource elements carrying the CRSs that should be used for channel estimation. Alternatively, processing circuitry may be provided for receiving and processing signals from the base station explicitly stating which resource elements carrying the CRSs that should not be used for channel estimation.

The processing circuitry 41, 42, 43, 44 described above can be implemented as program modules of a computer program comprising code means, which when run by a processor 45 in the user equipment 40 causes the user equipment 40 to perform the above-described functions and actions. The processor 45 need not be a single CPU (Central processing unit), but could comprise two or more processing units in the user equipment 40. For example, the processor may include general purpose microprocessors, instruction set processors and/or related chips sets and/or special purpose microprocessors such as ASICs (Application Specific

Integrated Circuit). The processor 45 may also comprise board memory for caching purposes. The computer program may be carried by a computer program product in the user equipment 40 comprising the processor 45. The computer program product comprises a computer readable medium on which the computer program is stored. For example, the computer program product may be a flash memory, a RAM (Random-Access Memory), ROM (Read-Only Memory) or an EEPROM (electrically erasable Programmable ROM) and the computer program modules described above could in alternative embodiments be distributed on different computer program products in the form of memories within the user equipment 40.

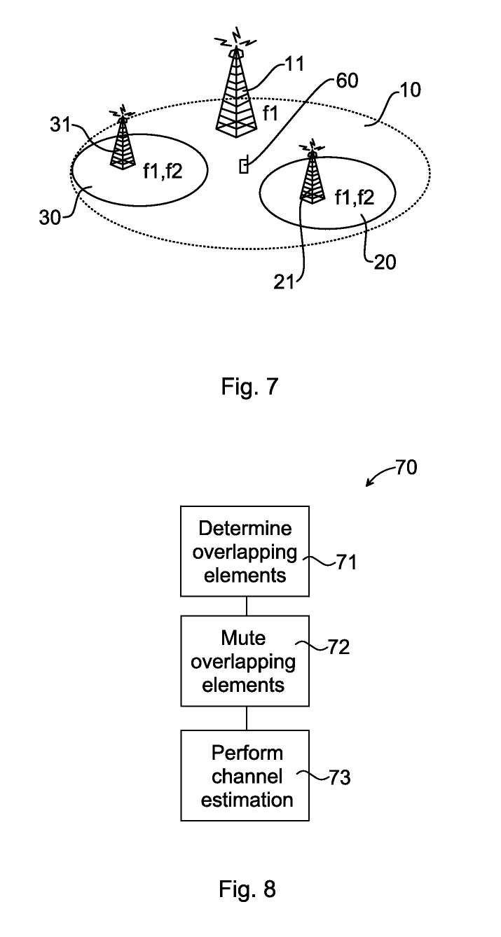

In the above description, the user equipment 40 is communicating with an under laid cell base station, for example pico cell base station 21, 31 and is interfered by transmissions from overlaid cell base station, for example macro base station 11. In another scenario, illustrated in FIG. 7, a user equipment 60 is instead communicating with an overlaid cell base station 11, the overlaid cell base station 11 being an aggressor base station. Regarding terminology, it is noted that an aggressor base station is a base station creating considerable interference to another base station, the other base station then being a victim base station (“victim” of interference).

An alternative embodiment is then, for the above scenario, that PDSCH transmitted from the overlaid cell base station (aggressor base station) mutes PDSCH resource elements that overlap with CRS resource elements from the first and second underlaid cell base stations 21, 31, these base stations being victim base stations. The overlaid cell base station 11 PDSCH resource elements transmitted from any antenna that overlap with any underlaid cell base station CRS resource elements from any antenna is to be muted.

PDSCH decoding without knowledge of this muting is possible but with lower performance. A typical decoder calculates soft values for bits modulated onto a resource element. If a resource element is muted, only interference and noise is present on this resource element and the calculated soft values do not represent the likelihood of bits modulated on this resource element.

In order to optimize PDSCH decoding of user equipments connected to the overlaid base station 11, the position of muted PDSCH resource elements is signaled to the user equipment 60. The decoder of the user equipment 60 then sets the soft values of the bits modulated on muted resource elements to zero. The required information is CRS frequency shift applied in the under laid cell base station and number of transmit antennas used in the under laid cell base station.

This embodiment thus provides a method in a user equipment 60 for channel estimation, wherein the user equipment 60 communicates within a wireless communication system 1 comprising at least two cells 10, 20, 30 arranged in a layered structure. The cells 10, 20, 30 comprise base stations 11, 21, 31 signaling at least partly on overlapping bandwidth fl, f2, and the user equipment 60 communicates with a base station 11 of an overlaid cell 10 of the layered structure.

With reference to FIG. 8, the method 70 comprises the first step of determining 71 PDSCH resource elements that overlap with resource elements carrying cell specific reference symbols transmitted from the underlaid cells 20, 30. The method 70 comprises the second step of muting 72 the PDSCH resource elements that overlap with the underlaid cell base station transmissions as determined in the first step. The method 70 comprises the third step of performing 73 channel estimation by utilizing the obtained information. In particular, as the user equipment 70 has knowledge about which resource elements are muted, the decoder of the user equipment may set soft values of bits modulated on muted resource elements to zero, which thus is an example on how to utilize the obtained information.

In another embodiment, the overlaid base station 11 does not mute the resource elements but takes them as empty resource elements into account when performing a rate matching step. In this case PDSCH is not mapped onto those resource elements. For this embodiment to function properly, it is of importance that the user equipment 40 is aware that PDSCH is not transmitted on certain resource elements, otherwise decoding would fail.

It is noted that although the invention has been described in connection with LTE advanced system, the invention can be applied to any cellular system using pilot symbols. As a few examples of such cellular systems 802.16e and 802.16m of the IEEE 802.16 standard can be mentioned.

1-11. (canceled)

12. A method in a user equipment for channel estimation, said user equipment communicating within a wireless communication system comprising at least two cells arranged in a layered structure, said at least two cells using at least partly overlapping bandwidth, and said user equipment communicating with a base station of an underlaid cell of said layered structure, said method comprising:
selecting, from among resource blocks scheduled for said user equipment in said underlaid cell, resource elements carrying cell-specific reference symbols, wherein said resource blocks (RBs) are within bandwidth used by said underlaid cell; and
performing said channel estimation by utilizing said selected resource elements carrying cell-specific reference symbols.

13. The method of claim 12, wherein said selecting comprises rejecting resource elements carrying cell-specific reference symbols overlapping with resource elements used for control signaling by a base station of said overlaid cell.

14. The method of claim 12, wherein said selecting comprises said user equipment estimating an interference level of RBs from said bandwidth used by said underlaid cell and basing said selection on the estimated interference level.

15. The method of claim 12, wherein said selecting comprises additionally selecting resource elements from among bandwidth not used by said overlaid cell.

16. The method of claim 12, wherein said selecting comprises:
detecting that no overlaid cell users are scheduled in accessible resource blocks; and
additionally selecting resource elements carrying cell-specific reference symbols from among said accessible resource blocks.

17. The method of claim 16, wherein said detecting comprises said user equipment determining interference from said accessible resource blocks by means of energy detection.

18. The method of claim 12, wherein said selecting comprises said user equipment obtaining signaling from said base station, said signaling indicating which resource elements carrying cell-specific reference symbols should be used for said channel estimation or said signaling indicating which resource elements carrying cell-specific reference symbols should not be used for said channel estimation.

19. The method of claim 12, wherein said selecting comprises selecting resource elements carrying cell-specific reference symbols from non-overlapping bandwidth.

20. The method of claim 12, wherein said RBs scheduled for said user equipment in said underlaid cell comprise PDSCH bandwidth.

21. A user equipment for communication within a wireless communication system comprising at least two cells arranged in a layered structure, said at least two cells using at least partly overlapping bandwidths, and said user equipment communicating with a base station of an underlaid cell of said layered structure, said user equipment comprising:
one or more processing circuits configured to select, from among resource blocks (RBs) scheduled for said user equipment in said underlaid cell, resource elements carrying cell-specific reference symbols, wherein said RBs are within bandwidth used by said underlaid cell, and
one or more processing circuits configured to perform said channel estimation by utilizing said selected resource elements carrying cell-specific reference symbols.

22. The user equipment of claim 21, further comprising one or more processing circuits configured to perform an additional selection of resource elements carrying cell-specific reference symbols from among bandwidth regions not used by said overlaid cell.
